(19) United States
(12) Patent Application Publication
(10) Pub. No.: US 2004/0017174 A1
(43) Pub. Date: Jan. 29, 2004

(54) Fuel cell system for consumers that are connected to a rechargeable battery

(76) Inventors: Rolf Bruck, Bergisch Gladbach (DE); Joachim Grosse, Erlangen (DE); Manfred Poppinger, Uttenreuth (DE); Meike Reizig, Bonn (DE)

Correspondence Address: LERNER AND GREENBERG, P.A., Post Office Box 2480, Hollywood, FL, 33022-2480, US

(21) Appl. No.: 10/426,518

(22) Filed: Apr. 30, 2003

Related U.S. Application Data
(63) Continuation of application No. PCT/DE01/04115, filed on Oct. 31, 2001.

(30) Foreign Application Priority Data
Oct. 31, 2000 (DE) 100 54 058.9

(51) Int. Cl. H02J 7/00

(52) U.S. Cl. 320/103

(57) ABSTRACT

Fuel cell units are suitable for continuous energy supply to electrical consumers. Particularly for the application in motor vehicles the above can either be the drive for an electric motor and/or also the supply of other electrical users. Here, a fuel cell module only delivers the electrical energy to a rechargeable battery and not directly to the user. The fuel cell module can thus be permanently held at the optimal operating point thereof. The fuel cell module preferably comprises HT-PEM fuel cells, which in contrast to PEM fuel cells work at a higher temperature, in particular in the range 120 C.° to 200 C.°.

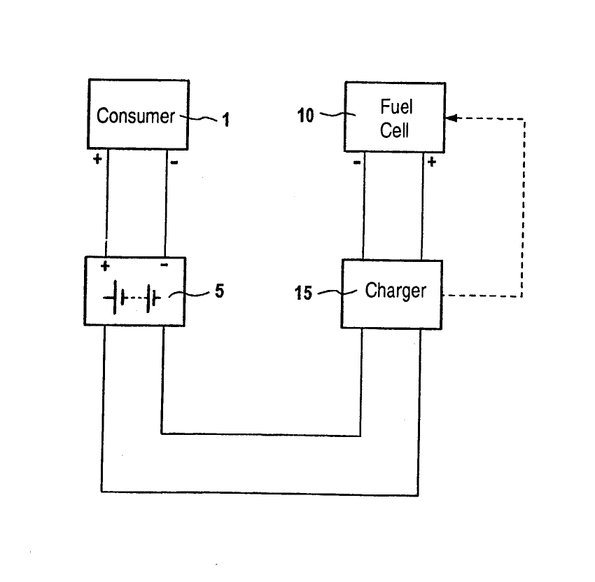

### CROSS-REFERENCE TO RELATED APPLICATION

This application is a continuation of copending International Application No. PCT/DE01/04115, filed Oct. 31, 2001, which designated the United States and which was not published in English.

### BACKGROUND OF THE INVENTION

### FIELD OF THE INVENTION

The invention lies in the fuel cell technology field. More specifically, the invention relates to a fuel cell system for consumers that are connected to a rechargeable battery. The fuel cell system has at least one fuel cell module. The invention also relates to the use of a fuel cell system of this type.

Fuel cell systems can be used wherever consumers are to be supplied with electric current. Suitable applications are in particular also those in which consumers have previously been connected to rechargeable batteries. In this case, the electrical energy which is generated by the fuel cell system is usually fed directly to the consumer. Since the operation of the consumer and therefore its power consumption may vary, in this case the fuel cell system is only operated when required. Such direct operation, however, is uneconomical when PEM fuel cells, in particular so-called HT-PEM fuel cell systems, are being used, since restarting fuel cells of this type, and in particular cold-starting them, always causes problems.

### SUMMARY OF THE INVENTION

It is accordingly an object of the invention to provide a fuel cell installation for supplying energy to a consumer that is connected to a battery, which overcomes the above-mentioned disadvantages of the heretofore-known devices and methods of this general type and which improves the operation of a fuel cell for supplying electricity to consumers.

With the foregoing and other objects in view there is provided, in accordance with the invention, a fuel cell system, comprising:

a fuel cell module connected to a rechargeable battery supplying a consumer, the fuel cell module supplying energy substantially only to the battery and operating substantially continuously at its optimum operating point.

In other words, according to the invention, the storage battery is charged by the fuel cell system itself. This has the advantage that the fuel cell system itself can be operated continuously and each fuel cell module can always be kept at its optimum operating point.

In accordance with an added feature of the invention, the fuel cell module is provided substantially only for charging the battery and the battery is connected to be otherwise independent.

In accordance with an additional feature of the invention, there is provided a charging module connected at an output side of the fuel cell module.

The installation according to the invention can advantageously be used for the on-board power supply of a motor vehicle, in particular if there was previously a storage battery for on-board power supply. An HT-PEM fuel cell system can be used particularly advantageously.

In accordance with a further feature of the invention, the fuel cell module contains polymer electrolyte membrane fuel cells. Preferably, as mentioned, the fuel cell module contains high-temperature polymer electrolyte membrane fuel cells. In that case, the high-temperature polymer electrolyte membrane (HT-PEM) fuel cells operate at temperatures between 60° C. and 300° C., preferably between 120° C. and 200° C.

In accordance with another feature of the invention, the high-temperature polymer electrolyte membrane fuel cells include a temperature-stable membrane filled with a self-dissociated and/or autoprotolytic electrolyte.

With the above and other objects in view the fuel cell system according to the invention, is implemented in an on-board power supply of a vehicle, where the above-outlined fuel cell system is used to supply electrical consumers on board the vehicle independently of whether the vehicle is running.

In accordance with a further feature of the invention, the consumer is an air-conditioning installation that is independent of the operation of the vehicle.

In accordance with a concomitant feature of the invention, the fuel cell module is configured to supply energy to the battery in dependence on a charge state of the battery or in dependence on a utilization, i.e., a power drain, of the battery by the consumer.

Other features which are considered as characteristic for the invention are set forth in the appended claims.

Although the invention is illustrated and described herein as embodied in a fuel cell system for consumers which are connected to a rechargeable battery, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The sole FIGURE is a circuit diagram illustrating the utilization of a fuel cell system.

### DESCRIPTION OF THE PREFERRED EMBODIMENTS

Referring now to the figure of the drawing in detail, there is shown an electrical consumer 1 which is supplied by a rechargeable battery 5. The consumer 1 may be of the type, for example, that is located in a motor vehicle. The vehicle is not illustrated for reasons of clarity. It will be understood that an on-board power supply is usually present in the motor vehicle. In the prior art, the rechargeable battery 5 is a storage battery that is recharged by way of the generator or alternator of the motor vehicle. The generator is dependent on the motor vehicle being driven, i.e., it provides output only when the vehicle is operated, and consequently the storage battery is only recharged when the motor of the motor vehicle is running.

A fuel cell system having at least one fuel cell module 10 is proposed herein for supplying the storage battery or the rechargeable battery 5. A charging module 15 is connected between the battery 5 and the fuel cell module 10. The charging module 15 is supplied by the fuel cell module 10. It will be understood that a control unit, which is not illustrated, is present and suitably connected.

When required, the charging module 15 is used to recharge the battery 5. Operation of the fuel cell module 10 is not affected by this and can therefore be set or kept at the optimum operating point. In particular, steady-state operation of the fuel cell module 10 is appropriate.

If appropriate, the fuel cell module 10 may be used as part of the fuel cell system for supplying further consumers of electricity. The configuration described herein has the advantage that the fuel cell system can be constantly run at its optimum operating point. Consequently, restarting or cold-starting, which often entails problems in fuel cell systems of this type, can be substantially avoided. Particularly favorable operation results when using fuel cell systems with PEM fuel cells (PEM, polymer electrolyte membrane, proton exchange membrane) or HT-PEM fuel cells (HT, high temperature). It is known that, although polymer electrolyte membrane fuel cells of this type operate satisfactorily in steady-state operation, problems may arise in particular in what is known as start/stop operation. While the PEM fuel cell usually operates at temperatures of approximately 60° C., the so-called HT-PEM fuel cells, which operate with a temperature-stable membrane and a self-dissociating and/or autoprotolytic electrolyte operate at higher temperatures, specifically between 60° C. and 300° C., in particular between 120° C. and 200° C. The fact that in this temperature range the fuel cell operation is independent of water, so that there is no need to wet the membrane, is advantageous.

However, the heat-up phase causes problems in particular when using HT-PEM fuel cells, since during this phase this lack of dependency on water, which is otherwise advantageous, does not apply. This problem can be substantially eliminated in conjunction with the rechargeable battery. Therefore, a fuel cell system with HT-PEM fuel cells can surprisingly be combined particularly successfully with a storage battery.

In addition to its use especially in the electric drive of motor vehicles, it is also possible to supply electrical consumers in motor vehicles with an internal combustion engine. Examples of electrical consumers of this type may be air-conditioning installations that are independent of driving and are increasingly being offered, in some cases as retrofitted extras. As a result, the on-board batteries which have previously been fitted in motor vehicles are in some cases subject to unacceptably high loads.

Information processing equipment (laptops) or information transmission equipment (mobile telephones) in vehicles have hitherto also been powered electrically by means of rechargeable batteries, and the batteries are drained in particular by a large number of consumers in constant operation. The invention can also be used in this context.

We claim:

1. A fuel cell system, comprising:
a fuel cell module connected to a rechargeable battery supplying a consumer, said fuel cell module supplying energy substantially only to the battery and operating substantially continuously at an optimum operating point thereof.

2. The fuel cell system according to claim 1, wherein said fuel cell module is provided substantially only for charging the battery and the battery is connected to be otherwise independent.

3. The fuel cell system according to claim 1, which comprises a charging module connected at an output side of said fuel cell module.

4. The fuel cell system according to claim 1, in combination with a motor vehicle, wherein said fuel cell module and the battery define an on-board power supply of the motor vehicle.

5. The fuel cell system according to claim 1, wherein said fuel cell module contains polymer electrolyte membrane fuel cells.

6. The fuel cell system according to claim 1, wherein said fuel cell module contains high-temperature polymer electrolyte membrane fuel cells.

7. The fuel cell system according to claim 6, wherein said high-temperature polymer electrolyte membrane fuel cells operate at temperatures between 60° C. and 300° C.

8. The fuel cell system according to claim 7, wherein said high-temperature polymer electrolyte membrane fuel cells operate at temperatures between 120° C. and 200° C.

9. The fuel cell system according to claim 7, wherein the high-temperature polymer electrolyte membrane fuel cells include a temperature-stable membrane filled with electrolyte selected from the group consisting of a self-dissociated electrolyte and autoprotolytic electrolyte.

10. In an on-board power supply of a vehicle, the fuel cell system according to claim 1 for supplying electrical consumers on board the vehicle independently of whether the vehicle is running.

11. The fuel cell system according to claim 10, wherein the consumer is an air-conditioning installation that is independent of the operation of the vehicle.

12. The fuel cell system according to claim 1, wherein said fuel cell module is configured to supply energy to the battery in dependence on a charge state of the battery or in dependence on a utilization of the battery by the consumer.
